(19) United States
(12) Patent Application Publication
(10) Pub. No.: US 2019/0184682 A1
(43) Pub. Date: Jun. 20, 2019

(54) Copper Alloy Article Containing Polyester-Based Resin and Method for Producing the Same

(71) Applicants: Advanced Technologies, Inc., Shizuoka (JP); National Institute of Advanced Industrial Science and Technology, Tokyo (JP)

(72) Inventors: Kinji Hirai, Kawasaki-shi, Kanagawa (JP); Takako Nakamura, Tsukuba-shi, Ibaraki (JP); Tetsuo Tsuchiya, Ushiku-shi, Ibaraki (JP)

(73) Assignees: Advanced Technologies, Inc., Shizuoka (JP); National Institute of Advanced Industrial Science and Technology, Tokyo (JP)

(21) Appl. No.: 16/310,300

(22) PCT Filed: Jun. 14, 2017
(86) PCT No.: PCT/JP2017/022001

§ 371 Date: Dec. 14, 2018

(30) Foreign Application Priority Data
Jun. 15, 2016 (JP) 2016-119105

(51) Int. Cl. B32B 15/09; B32B 15/20; B32B 27/16

(52) U.S. Cl. CPC B32B 15/09; B32B 15/20; B32B 27/16; B32B 2307/538; B32B 38/0036; B32B 2310/0831; B32B 2311/12; B32B 2367/00; B32B 2457/08

(57) ABSTRACT

Disclosed is a copper alloy article 1 including: a substrate 10 made of a copper alloy; a polyester-based resin body 40; and an intermediate layer 30 disposed between the substrate 10 and the polyester-based resin body 40, wherein the intermediate layer 30 contains an oxygen functional group.

### TECHNICAL FIELD

The present disclosure relates to a copper alloy article including a copper alloy in which a polyester-based resin member is bonded to at least a part of a surface thereof, and a surface-modified polyester-based resin member suitable for producing a copper alloy article, and a method for producing the same.

### BACKGROUND ART

Copper alloys have widely been used in electric and electronic components as rolled materials, expanded materials, foil materials and plating materials because of excellent electrical conductivity and thermal conductivity. Copper alloys are indispensable materials as wiring materials, and electronic circuit boards (printed wiring boards) in which a copper wiring and an insulating layer mainly made of a resin are composited are used in electronic devices. The printed wiring boards include rigid printed wiring boards using, as the material of an insulating layer, materials having no flexibility obtained by impregnating a glass fiber with a resin material such as an epoxy resin and curing the resin material, and flexible printed wiring boards (hereinafter referred to FPC) using, as the material of an insulating layer, thin flexible resin materials such as a polyimide film and a polyester film.

In any printed board, there is a need to increase the bonding force between the resin material and the copper wiring, and various techniques have been proposed. For example, there has been known a flexible copper clad laminate (FCCL) using, as the base material used for FPC, a material obtained by bonding a copper foil to one or both surfaces of a resin film. To improve the bonding strength between the resin film and the copper foil, there has been used a method in which a surface of the copper foil is roughened and an adhesive or a heated resin surface is adhered to irregularities of the roughened surface (anchor effect).

However, in high frequency signal, signal flows through a surface layer of the wiring due to the effect called the skin effect, so that if the surface of the copper foil has irregularities, the transmission distance becomes longer leading to increased transmission loss. Therefore, in the transmission loss which is an important characteristic of FPC, in order to achieve low transmission loss, it is required that the surface of the copper foil has high smoothness. Therefore, there is required a method capable of bonding a copper foil having a smooth surface and a resin material with high strength.

Patent Document 1 discloses a circuit board (multi-layered wiring board) in which, in a circuit board using a resin cured product as an insulating layer, in order to obtain high adhesion between a copper wiring layer having a particularly smooth surface and an insulating layer, a copper oxide layer present on a surface of the copper wiring layer is substituted or coated with an oxide and/or a hydroxide of other metals such as tin, zinc, chromium, cobalt and aluminum to form a layer of an amine-based silane coupling agent having a silanol group or a mixture thereof, which is covalently bonded to the oxide and hydroxide layers, and a vinyl-based silane coupling agent layer having a carbon-carbon unsaturated double bond is further formed thereon to form a covalent bond with a vinyl group contained in a resin cured article of the insulating layer.

There is disclosed, as the method for producing a circuit board, a method including the followings: a copper oxide layer on a copper surface is substituted or coated with a metal oxide layer and/or a hydroxide layer made of tin, zinc, chromium, cobalt and aluminum by plating, sputtering or vapor deposition; the metal oxide and hydroxide layers increase the adhesion between the silane coupling agent and the metal layer; the residual silanol group in the amine-based silane coupling agent layer and the silanol group of the vinyl-based silane coupling agent layer form a covalent bond; a carbon-carbon unsaturated double bond of the vinyl-based silane coupling agent forms a covalent bond with the vinyl compound in the insulating layer; and the resin cured article of the insulating layer is cured under pressure and heat.

This circuit board is complicated in configuration and complicated in production process.

Patent Document 2 discloses a flexible laminate in which a silane coupling agent is interposed between a film for a base of polyethylene naphthalate (PEN) which is a polyester-based resin and a conductive layer of copper. The patent document mentions that a hydrolyzable functional group of a silane coupling agent reacts with water to form a silanol group and bonds with metal such as copper, and an organic functional group is bonded to PEN by the reaction. There is also disclosed a lamination step in which a copper alloy is laminated on a film for a base coated with a silane coupling agent by a sputtering method, followed by subjecting to copper plating to form a conductive layer.

Patent Documents 3 to 6 disclose a material of copper or aluminum whose surface is not roughened, or a surface-treated metallic material in which a plated material obtained by subjecting the metallic material to silver, nickel or chromate plating is surface-treated with a silane or titanium coupling agent. The patent documents also disclose a method of producing a composite in which a liquid crystal polymer (hereinafter referred to as LCP) film having a polyester structure is pressure-bonded to the surface-treated metallic material or a polymer is bonded by injection molding. The patent documents mention that a coupling agent for a surface treatment of metal or a plated material thereof is preferably a coupling agent having a nitrogen-containing functional group, i.e., an amine-based silane or titanium coupling agent, which is effective because the coupling agent satisfactorily adheres to metals and has high peel strength.

Patent Document 7 discloses a surface treatment agent containing a novel amino group- and alkoxysilane group-containing triazine derivative compound. The patent document discloses that these materials can be bonded to each other by applying a surface treatment agent containing this novel compound to various metallic materials and polymer materials, followed by hot pressing. The patent document also mentions that, when the novel compound is surface-treated and coated with other reagents, a reaction between the functional group present in the film of the novel compound and other reagents occurs, thus being converted to a material having various functions.

Patent Document 8 discloses a resin/copper plating laminate which has high peel bonding strength without performing surface modification of a resin substrate or a resin film by a plasma treatment or etching in a laminate including the resin substrate or the resin film and copper plating. Specifically, a surface of noble metal particles serving as an electroless metal plating catalyst is coated with a sucrose-derived compound to form a colloid, and then the resin substrate or resin film, to which the colloid is adsorbed, is treated with ozone, a hydrogen peroxide solution, an aqueous alkali solution or the like. Thereby, a hydroxyl group or a carboxyl group is formed on a surface of the sucrose-derived compound, so that when treated with a silane coupling agent, the colloid and the silane coupling agent are bonded to each other. The patent document mentions that the silane coupling agent is hydrolyzed in an electroless plating solution to form a silanol group, which is bonded to a metal surface, thereby, a strong underlying metal layer can be formed on the surface of a resin substrate by electroless plating and, when copper plated is performed, it is possible to obtain a laminate having high adhesion strength between the resin substrate and the copper foil film.

### PRIOR ART DOCUMENT

### Patent Document

Patent Document 1: JP 2011-91066 A

Patent Document 2: JP 2010-131952 A

Patent Document 3: JP 2014-27042 A

Patent Document 4: JP 2014-27053 A

Patent Document 5: JP 2014-25095 A

Patent Document 6: JP 2014-25099 A

Patent Document 7: WO 2013/186941 A

Patent Document 8: JP 2013-184425 A

### DISCLOSURE OF THE INVENTION

### Problems to be Solved by the Invention

When a polyester-based resin film, e.g., a liquid crystal polymer (LCP) is used as an insulating material for forming a printed wiring board, there is an advantage that the transmission loss of the high frequency signal transmission line can be reduced. However, when the polyester-based resin material and the copper wiring are bonded to each other with the silane coupling agent disclosed in Patent Documents 1 to 6, the reaction of the coupling agent may not proceed as expected due to the chemical structure of the polyester-based resin. Therefore, an error in bonding strength between the polyester-based resin material and the copper wiring may increase (i.e., inferior reproducibility of the bonding strength), leading to a decrease in bonding strength.

Since the novel compound disclosed in Patent Document 7 has an amino group and an alkoxysilane group introduced into a triazine ring, when a surface treatment agent containing the compound is used, the chemical bondability between the metal and resin increases as compared with the existing silane coupling agent. However, even when the polyester-based resin material and the copper wiring are bonded to each other using a surface treatment agent, it is impossible to obtain sufficient bonding strength.

Thus, an object of the present disclosure is to provide a copper alloy article in which a polyester-based resin body and a copper alloy substrate are bonded to each other with sufficiently high bonding strength, and a method for producing thereof.

### Means for Solving the Problems

The inventors of the present invention have intensively studied so to solve the above problems and found solution means with the following configurations, thus completing the present invention.

An aspect 1 of the present invention is directed to a copper alloy article including:

a substrate made of a copper alloy;

a polyester-based resin body; and

an intermediate layer disposed between the substrate and the polyester-based resin body, wherein

the intermediate layer contains an oxygen functional group.

An aspect 2 of the present invention is directed to the copper alloy article according to the aspect 1, further including:

a compound layer between the substrate and the intermediate layer, wherein

the compound layer contains a compound having a nitrogen-containing functional group and a silanol group.

An aspect 3 of the present invention is directed to the copper alloy article according to the aspect 2, wherein the nitrogen-containing functional group has a nitrogen-containing 5-membered or higher-membered cyclic structure.

An aspect 4 of the present invention is directed to the copper alloy article according to the aspect 3, wherein the 5-membered or higher-membered cyclic structure is a triazole or triazine structure.

An aspect 5 of the present invention is directed to a copper alloy article according to any one of the aspects 1 to 4, wherein the polyester-based resin body is made of a polyester-based resin selected from the group consisting of polyethylene terephthalate, polymethylene terephthalate, polybutylene terephthalate, polyethylene naphthalate, polybutylene naphthalate and a liquid crystal polymer.

An aspect 6 of the present invention is directed to the copper alloy article according to any one of the aspects 1 to 5, wherein the substrate has a surface roughness Ra of 0.1 μm or less.

An aspect 7 of the present invention is directed to the copper alloy article according to any one of the aspects 1 to 6, wherein an oxide layer and a rust preventive layer are absent on a surface of the substrate.

An aspect 8 of the present invention is directed to a polyester-based resin member including:

a polyester-based resin body; and

an intermediate layer containing an oxygen functional group on a surface of the polyester-based resin body.

An aspect 9 of the present invention is directed to the polyester-based resin member according to the aspect 8, further including:

a compound layer on the intermediate layer, wherein

the compound layer contains a compound having a nitrogen-containing functional group and a silanol group.

An aspect 10 of the present invention is directed to the polyester-based resin member according to the aspect 9, wherein the nitrogen-containing functional group has a nitrogen-containing 5-membered or higher-membered cyclic structure.

An aspect 11 of the present invention is directed to the polyester-based resin member according to the aspect 10, wherein the 5-membered or higher-membered cyclic structure is a triazole or triazine structure.

An aspect 12 of the present invention is directed to the polyester-based resin member according to any one of the aspects 8 to 11, wherein the polyester-based resin body is made of a polyester-based resin selected from the group consisting of polyethylene terephthalate, polymethylene terephthalate, polybutylene terephthalate, polyethylene naphthalate, polybutylene naphthalate and a liquid crystal polymer.

An aspect 13 of the present invention is directed to a copper alloy member including:

a substrate made of a copper alloy; and

a compound layer on a surface of the substrate, wherein

the compound layer contains a compound having a nitrogen-containing functional group and a silanol group.

An aspect 14 of the present invention is directed to the copper alloy member according to the aspect 13, wherein the nitrogen-containing functional group has a nitrogen-containing 5-membered or higher-membered cyclic structure.

An aspect 15 of the present invention is directed to the copper alloy member according to the aspect 14, wherein the 5-membered or higher-membered cyclic structure is a triazole or triazine structure.

An aspect 16 of the present invention is directed to a method for producing a copper alloy article including a substrate made of a copper alloy, a polyester-based resin body, a compound layer and an intermediate layer disposed between the substrate and the polyester-based resin body, the method including:

irradiating a surface of the polyester-based resin body with ultraviolet light in the presence of a hydrogen peroxide solution to form an intermediate layer containing an oxygen functional group on the surface of the polyester-based resin body;

bringing the intermediate layer into contact with a solution containing a compound having a nitrogen-containing functional group and a silanol group, followed by a heat treatment to form a compound layer;

cleaning a surface of the substrate with an aqueous acid solution; and

bonding the compound layer and the cleaned surface of the substrate to each other, thereby bonding the substrate and the polyester-based resin body to each other.

An aspect 17 of the present invention is directed to a method for producing a copper alloy article including; a substrate made of a copper alloy, a polyester-based resin body, and a compound layer and an intermediate layer disposed between the substrate and the polyester-based resin body, the method including:

irradiating a surface of the polyester-based resin body with ultraviolet light in the presence of a hydrogen peroxide solution to form an intermediate layer containing an oxygen functional group on a surface of the polyester-based resin body;

cleaning the substrate with an aqueous acid solution;

bringing the cleaned substrate into contact with a solution containing a compound having a nitrogen-containing functional group and a silanol group, followed by a heat treatment to form a compound layer; and

bonding the intermediate layer and the compound layer to each other, thereby bonding the substrate and the polyester-based resin body to each other.

An aspect 18 of the present invention is directed to a method for surface modification of a polyester-based resin body, the method comprising:

irradiating a surface of the polyester-based resin body with ultraviolet light in the presence of a hydrogen peroxide solution to form an intermediate layer containing an oxygen functional group on the surface.

An aspect 19 of the present invention is directed to the method according to the aspect 18, wherein the intermediate layer formed on the surface is brought into contact with a compound having a nitrogen-containing functional group and a silanol group, followed by a heat treatment to form a compound layer.

### Effects of the Invention

According to the present invention, it has been found that modification of a surface of the polyester-based resin body with an oxygen functional group leads to an improvement in pressure bondability of the polyester-based resin body. Thereby, the polyester-based resin body and the copper alloy substrate can be bonded to each other through an intermediate layer which contains an oxygen functional group and is interposed therebetween, with sufficient bonding strength.

### BRIEF DESCRIPTION OF THE DRAWINGS

FIG. 1 is a schematic cross-sectional view of a copper alloy article according to Embodiment 1 of the present invention.

FIGS. 2(a) and 2(b) are schematic cross-sectional views for explaining a method for producing a copper alloy article according to Embodiment 1.

FIG. 3(a) is an XPS spectrum of an untreated LCP film surface and FIG. 3(b) is an XPS spectrum of an LCP film surface after an oxygen functionalization treatment.

FIG. 4(a) is an XPS spectrum of an untreated LCP film surface and FIG. 4(b) is an XPS spectrum of an LCP film surface after an oxygen functionalization treatment. FIG. 5(a) is an IR spectrum of an untreated LCP film surface and FIG. 5(b) is an IR spectrum of an LCP film surface after an oxygen functionalization treatment.

FIG. 6 is an XPS spectrum of a CT-F peeling interface between a copper foil and an LCP film (CT-F) bonded to each other.

FIG. 7 is a schematic cross-sectional view of a copper alloy article according to the second embodiment of the present invention.

FIG. 8 is an XPS spectrum of an LCP film surface coated with ImS.

FIG. 9 is an XPS spectrum of an LCP film surface coated with AAS.

FIGS. 10(a) to 10(c) are schematic cross-sectional views for explaining a first method for producing a copper alloy article according to Embodiment 2.

FIGS. 11(a) and 11(b) are schematic cross-sectional views for explaining a second method for producing a copper alloy article according to Embodiment 2.

### MODE FOR CARRYING OUT THE INVENTION

The inventors of the present invention have found that there is a problem that sufficient bonding strength cannot be obtained even when using a conventional silane coupling agent in the case of bonding a polyester-based resin body and a copper alloy substrate to each other. As a result of intensive study so as to solve the above problem, it has been found that modification of a surface of the polyester-based resin body with an oxygen functional group enables pressure bonding of a polyester-based resin body and a copper alloy substrate to each other with sufficiently high bonding strength, thus completing the copper alloy article according to the present disclosure.

That is, the present disclosure is directed to a copper alloy article in which a copper alloy substrate and a polyester-based resin body are bonded to each other through an intermediate layer which contains an oxygen functional group and is interposed therebetween.

Embodiments according to the present invention will be described below.

### Embodiment 1

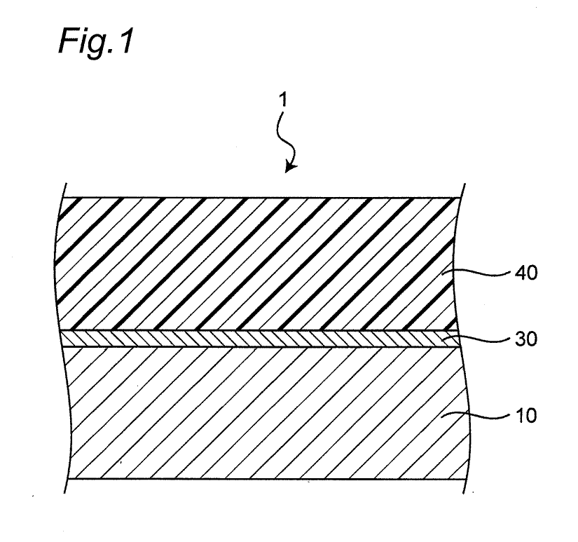

FIG. 1 is a schematic cross-sectional view of a copper alloy article 1 according to Embodiment 1, in which a copper alloy substrate 10 and a polyester-based resin body 40 are bonded to each other through an intermediate layer 30 which contains an oxygen functional group and is interposed therebetween. The “oxygen functional group” is an oxygen-containing functional group and includes, for example, a hydroxyl group, a carbonyl group, an epoxy groups, and a carbonyl group.

As used herein, an intermediate layer containing an oxygen functional group is referred to as the “oxygen-containing functional group layer”.

The copper alloy substrate 10 is made of pure copper or various copper alloys, and any copper alloy used industrially can be used as the copper alloy.

For the copper alloy substrate 10, for example, a copper foil such as an electrolytic copper foil or a rolled copper foil can be applied. In particular, a rolled copper foil having high flexibility is suitable for FPC.

The polyester-based resin body 40 is made of a polyester-based resin. The polyester-based resin is, for example, a polycondensate of a polyvalent carboxylic acid (dicarboxylic acid) and a polyalcohol (diol). Polyethylene terephthalate (PET), polymethylene terephthalate, polybutylene terephthalate, polyethylene naphthalate, polybutylene naphthalate and a liquid crystal polymer (LCP) are suitable. These polyester-based resins have particularly high effect of improving the pressure bondability due to formation of an oxygen-containing functional group layer 30, so that it is possible to bond a copper alloy substrate 10 and a polyester-based resin body 40 to each other with sufficient bonding strength only by interposing the oxygen-containing functional group layer 30 therebetween.

For the polyester-based resin body 40, for example, a polyester-based resin film, a polyester-based resin plate or the like can be employed. In particular, an LCP film has low dielectric constant and low dielectric loss tangent in material properties, so that it has an advantage that the transmission loss of the high frequency signal line is reduced particularly when applied to FPC. Furthermore, since the LCP film has very low water absorption rate, it exhibits satisfactory dimensional stability even under high humidity.

As an example, detailed description will be made of a copper alloy article using a rolled copper foil as the copper alloy substrate 10 and using an LCP film as the polyester-based resin body. It is also possible to similarly configure and produce the copper alloy article 1 using the copper alloy substrate 10 and the polyester-based resin body 40 in other forms.

### (1) Selection of Rolled Copper Foil

In Embodiments 1 and 2, in order to reduce the transmission loss of high frequency signals on the printed circuit board, the copper alloy substrate 10 preferably has a flat surface. In Embodiment 2 mentioned later, it is preferable that the copper alloy is exposed on the surface of the copper alloy substrate 10. Therefore, investigation is made of a selection method of the copper alloy substrate 10 suitable for any embodiment.

First, three types of commercially available copper foils (copper foils A to C) are selected for a copper foil having a thickness of 18 μm, which is most demanded by FPC, and measurement of the surface layer was performed by X-ray photoelectron spectroscopy (XPS)

TABLE 1

| | | Surface | | |
|---|---|---|---|---|
| Copper | Surface layer | roughness (pm) | | |
| foil | XPS analysis | Rₐ | R_{z} | Remarks |
| A | Zinc plating | — | 0.75 | Used in existing FCCL |
| B | Oxide, Rust preventive | 0.05 | 0.4 | Slight oil spots |
| C | Oxide, Rust preventive | 0.15 | — | Significant oil spots |

A copper foil A is used for existing FPC and, when measured by XPS, zinc was detected. Namely, it has been found that the copper foil A is galvanized. Since a copper foil having no plating layer is preferable as a copper foil suitable for Embodiment 2, the copper foil A was excluded.

Although there was no plating layer on the surface of the copper foils B and C, elements derived from oxidation of copper and the rust preventive applied to the copper foil surface (e.g., oxygen, etc.) were detected.

With respect to these copper foils B and C, the measurement of the surface roughness and electron microscope (SEM) analysis of the surface were performed.

The surface roughness Ra was measured by a laser microscope. The copper foil B had Ra of 0.05 μm and the copper foil C had Ra of 0.15 μm.

As a result of confirming wrinkle-like dents (oil spots) on the surface by SEM observation, slight oil spots were observed in the copper foil B as compared with the copper foil C.

From these results, it was judged that the copper foil B had higher surface smoothness, and the copper foil B was used as the copper alloy substrate 10.

### (2) Cleaning of Copper Foil (Copper Alloy Substrate 10)

A commercially available copper foil is coated with a rust preventive. On a surface of the copper foil, an oxide layer can be formed with passage of time. In the case of a copper alloy article such as FCP, in order to exhibit properties of the copper foil, for example, electric conductivity to the utmost, it is desired that the rust preventive and the oxide layer are removed from the surface of the copper foil to expose copper on the surface of the copper foil. In order to do that, there is a need to perform cleaning (acid cleaning) to remove the rust preventive and the oxide layer before using the copper foil. Therefore, using the copper foil B as a sample, the conditions of acid cleaning were investigated.

As a cleaning solution, 15% sulfuric acid and 1% hydrochloric acid were used at room temperature. The sample was immersed in a cleaning solution for 0 minute (without cleaning), 1 minute and 5 minutes, taken out from the cleaning solution, sufficiently washed with ion exchanged water, and then dried. Thereafter, the surface of the sample was analyzed by XPS to determine the cleaning level.

The cleaning level of the copper foil surface after acid washing was judged whether or not the rust preventive remains on the surface. Specifically, the copper foil surface after cleaning was measured by XPS and qualitatively judged according to the presence or absence of a peak of nitrogen (N) (peak of nitrogen N1orbit at binding energy of around 400 eV) derived from the rust preventive. The case where a peak attributed to nitrogen (N) could be confirmed in the XPS spectrum was judged to be “present”, whereas, the case where a peak could not be confirmed was judged to be “none”. The measurement results are shown in Table 2.

The oxide layer can also be used as evaluation criteria for the cleaning level. However, even if the oxide layer can be completely removed from the surface of the copper foil by acid cleaning, copper on the copper foil surface reacts with oxygen in the atmosphere to form a trace amount of an oxide at the moment when the copper foil is taken out from the cleaning solution. In surface analysis by XPS, the trace amount of the oxide is also detected, so that t is difficult to accurately judge the cleaning level.

TABLE 2

Immersion time

| Cleaning solution | 0 minute | 1 minutes | 5 minutes |
|---|---|---|---|
| 15% Sulfuric acid | Present | None | None |
| 1% Hydrochloric acid | Present | None | None |

As shown in Table 2, in the case of any cleaning solution (aqueous acid solution), the peak derived from the nitrogen N1s orbital disappeared from the copper foil surface within the immersion time of 1 minute, leading to a minor peak of the Cu2p orbital derived from the oxide. Therefore, it was judged that the rust preventive and the oxide adhered to the copper foil can be removed by immersing in the cleaning solution for 1 minute. In the following embodiments, a copper foil cleaned with 1% hydrochloric acid for 1 minute, which is easy to handle, is used.

Even in the copper alloy article using the copper foil, it can be seen that a copper foil cleaned with an acid was used by XPS analysis of the surface of the copper foil peeled off from the copper alloy article, thereby confirming the peak derived from the N1s orbital and the peak derived from the Cu2p orbital. It is possible to confirm that no rust preventive is present since the peak derived from the N1s orbit is not detected. It is possible to confirm that no oxide layer is present due to minor peak derived from Cu—O present at around 935 eV (e.g., a peak intensity of 1/10 or less, particularly a peak intensity of 1/20 or less, of the peak intensity of (Cu(0)) present at around 935 eV) with respect to the peak derived from the Cu2p orbital. As mentioned above, even if the copper foil is cleaned with an acid to remove the oxide layer, a small amount of the oxide is formed by extracting into the atmosphere thereafter. However, since such a trace amount of the oxide does not substantially affect properties (particularly, the bonding force with the polyester-based resin body) of the copper foil, it is considered that there is substantially no oxide layer.

### (3) Selection of LCP Film (Polyester-Based Resin Body 40)

Suitable for the production of FCP is suitable as the LCP film. In FCP, two types of LCP films are used. One is a film for a base, which is used for the base portion of a laminated substrate. The other one is a film for a cover, which is used for covering a laminated substrate.

The film for a base is required to have physical properties such as heat resistance capable of withstanding a heat treatment during the production of FCP, and tensile strength and edge tearing strength required for the laminated substrate which is not easily broken. Examples of the LCP film suitable for the film for a base include those having physical properties such as a melting point of 300 to 350° C., a tensile strength of 250 to 350 MPa and an edge tearing strength of 15 to 20 kgf.

The film for a cover may have lower heat resistance, tensile strength and tear strength than those of the film for a film for a base, but instead, the film for a cover is required to be thermally weldable below the melting point of the film for a base. Examples of the LCP film suitable for the film for a cover include those having physical properties such as a melting point 250 to 300° C., a tensile strength 150 to 250 MPa and an edge tearing strength of 10 to 15 kgf.

### (4) Formation of Oxygen-Containing Functional Group of LCP Film (Polyester-Based Resin Body 40)

As a result of intensive study, the inventors of the present invention have found that it is suitable to use a hydrogen peroxide solution so as to form an oxygen-containing functional group on a surface of a polyester-based resin.

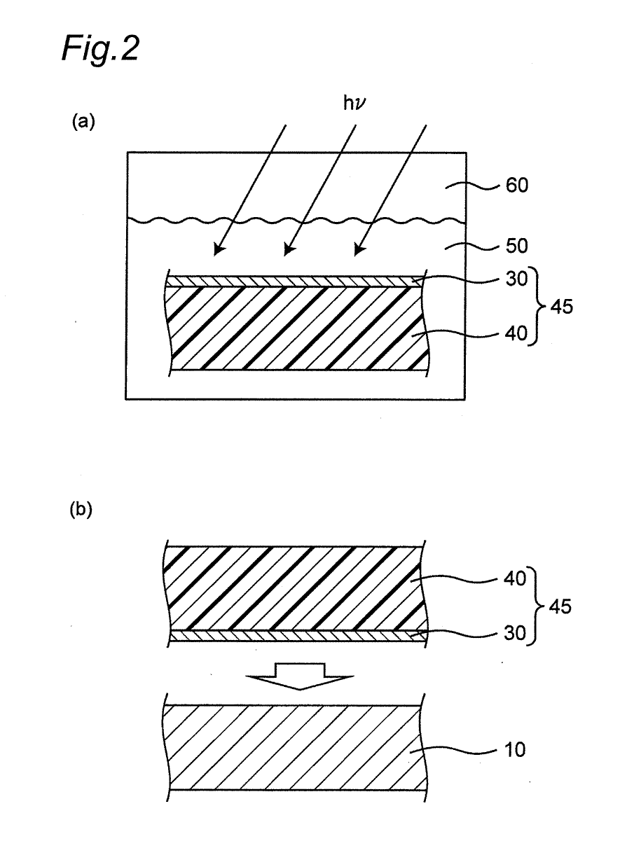

Upon reaction, irradiation with ultraviolet light was performed in a state where the polyester-based resin body is immersed in a hydrogen peroxide solution (FIG. 2(a)). In the method according to the embodiment of the present invention, ultraviolet degradation of hydrogen peroxide and surface excitation of the polyester-based resin are important. Therefore, it is preferable to set a wavelength of ultraviolet rays at 170 nm to 400 nm. As mentioned above, in the embodiment of the present invention, light having a wide range of a wavelength can be employed. In order to increase the efficiency of the reaction, it is more preferable to perform the reaction by irradiating with ultraviolet light having a wavelength of 250 nm or less.

The dose and the irradiation time of ultraviolet rays are not particularly limited as long as an appropriate reaction (i.e., ultraviolet degradation of hydrogen peroxide and surface excitation of a polyester-based resin) proceeds on a surface of a polyester-based resin body 40 to form an oxygen-containing functional layer 30. For example, the dose can be set in a range of 0.1 to 100 mW/cm² and the irradiation time is preferably set about 1 minute to 7 hours. The exemplified numerical range is a preferable range, and it is not particularly limited thereto.

As a light source of ultraviolet rays, a known light source can be used. Examples thereof include a low pressure mercury lamp, a high pressure mercury lamp, an ArF or XeCl excimer laser, an excimer lamp, a metal halide lamp and the like.

The reaction on the surface of the polyester-based resin body 40 by a hydrogen peroxide solution and ultraviolet rays easily proceeds at room temperature. This is one of the large features of the present invention.

By treating (hereinafter referred to as the oxygen functionalization treatment) the polyester-based resin body 40 as mentioned above, a polyester-based resin body 45 including the polyester-based resin body 40 and a layer containing an oxygen-containing functional group (oxygen-containing functional group layer 30) formed on the surface thereof was obtained.

It was confirmed by analysis whether or not the oxygen-containing functional layer 30 is newly formed on the surface of the polyester resin member 45 (more strictly, whether or not the oxygen-containing functional group is chemically bonded to the surface of the polyester-based resin body 40). Various analytical instruments can be used, and XPS measurement is particularly preferable because it is possible to confirm the oxygen/carbon atom ratio and the carbon-oxygen bonding mode.

Since the oxygen-containing functional group is a polar group such as a hydroxyl group, a carbonyl group, an epoxy group, or a carboxyl group, when the oxygen-containing functional layer 30 is formed, the hydrophilicity of the surface of the polyester resin member 45 is improved. Therefore, it is possible to confirm the hydrophilicity, i.e., formation of the oxygen-containing functional layer 30 on the surface, by measuring a contact angle of the surface of the polyester resin member 45 with water.

The confirmation method of the oxygen-containing functional layer 30 and the confirmation results thereof will be specifically described below.

### Preparation of Sample for Measurement

Two types of LCP films (Vecstar CT-Z, CT-F, manufactured by Kuraray Co., Ltd.) were prepared as the polyester-based resin body 40. CT-Z is a film for a base and CT-F is a film for a cover. Physical property values of CT-Z and CT-F are shown in Table 3.

TABLE 3

| | |
|---|---|
| CT-Z | CT-F |

| | | |
|---|---|---|
| Type | Film for base | Film for cover |

| | | | | |
|---|---|---|---|---|
| Melting point | 335° | C. | 280° | C. |
| Tensile strength | 330 | MPa | 240 | MPa |
| Edge tearing strength | 18 | kgf | 9 | kgf |

As shown in FIG. 2(a), a polyester-based resin body 40 and a 30% hydrogen peroxide solution 50 were charged in a reaction vessel 60 made of synthetic quartz, and then an oxygen functionalization treatment was performed by irradiating with ultraviolet rays (hν) at room temperature for 30 minutes to 3 hours using an excimer lamp. Thereafter, the LCP film having the oxygen-containing functional layer 30 formed on a surface thereof (polyester-based resin member 45) was washed with pure water and dried under reduced pressure to obtain a sample for measurement. For comparison, an untreated LCP film was also prepared for measurement.

### XPS Analysis

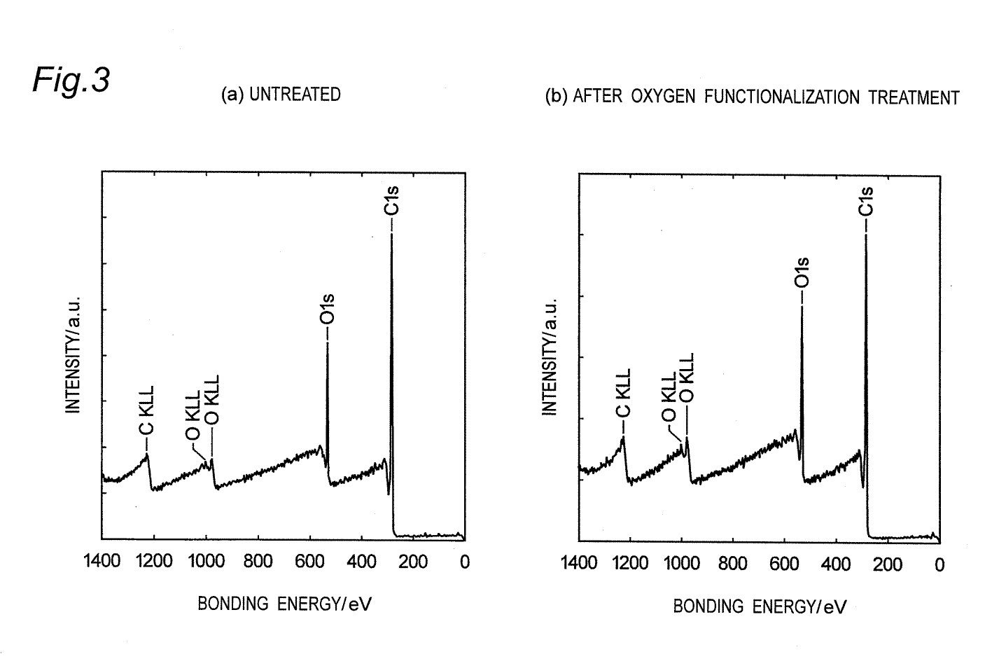

First, measurement was made using CT-Z of two types of LCP films. FIG. 3(a) shows an XPS spectrum of an untreated CT-Z and FIG. 3(b) shows an XPS spectrum of CT-Z subjected to an oxygen functionalization treatment by irradiating with ultraviolet rays for 30 minutes to 3 hours, respectively. The analysis results of the XPS spectra are shown in Table 4.

TABLE 4

| LCP | | Oxygen/carbon | Contact angle |
|---|---|---|---|
| film | Treatment | atom ratio | to water |
| CT-Z | Untreated | 0.19 | 87° |
| | Oxygen functionalized | 0.26 | 60° |
| CT-F | Untreated | 0.25 | 83° |
| | Oxygen functionalized | 0.35 | 57° |

In the XPS spectrum, a peak of C1s appears at around 285 eV and a peak of is orbital (O1s) of oxygen appears at around 530 eV. Comparing the XPS spectra of FIGS. 3(a) and 3(b), the height of O1s increased after the oxygen functionalization treatment. As shown in Table 4, the oxygen/carbon atom ratio determined from the XPS spectrum was 0.19 in the untreated CT-Z, and it became 0.26 after the oxygen functionalization treatment. That is, an increase in oxygen/carbon atom ratio was observed by the oxygen functionalization treatment. Thereby, it was confirmed that an oxygen-containing functional group was newly introduced onto the surface of the LCP film (i.e., the oxygen-containing functional layer 30 was formed).

By the same method, XPS analysis of CT-F of two types of LCP films was also performed to determine the oxygen/carbon atom ratio. The results are shown in Table 4.

Comparing the difference in two types of LCPs, the oxygen/carbon atomic ratio was 0.19 in the untreated CT-Z, whereas, the oxygen/carbon atomic ratio was large, e.g., 0.25 in the untreated CT-F. This shows that there is a difference in resin molecules constituting the film in two types of LCP.

Comparing the effect of the oxygen functionalization treatment between CT-Z and CT-F, the oxygen/carbon atomic ratio was 0.19 in the untreated CT-Z and the oxygen/carbon atomic ratio became 0.26 after the oxygen functionalization treatment. The oxygen/carbon atomic ratio was 0.25 in the untreated CT-F and the oxygen/carbon atomic ratio became 0.35 after the oxygen functionalization treatment. That is, an increase in oxygen/carbon atom ratio was observed by the oxygen functionalization treatment.

It was found that the oxygen-containing functional layer 30 can be formed on the surface by the oxygen functionalization treatment in both two types of LCPs.

Measurement of Contact Angle with Water

A contact angle with water of two types of LCP films (CT-Z, CT-F) was measured by the drop method. The results are shown in Table 4.

As is apparent from a comparison with the contact angle of the untreated CT-Z of 87°, the contact angle of CT-Z subjected to the oxygen functionalization treatment decreased to 60°, leading to an improvement in hydrophilicity. As is apparent from a comparison with the contact angle of the untreated CT-F of 83°, the contact angle of CT-F subjected to the oxygen functionalization treatment decreased to 57°, leading to an improvement in hydrophilicity.

As mentioned above, it was confirmed that an oxygen-containing functional group was introduced onto the surface by irradiation with light from an excimer lamp in the presence of hydrogen peroxide in any of the LCPs of CT-Z and CT-F.

### Specification of Types of Oxygen Functional Group

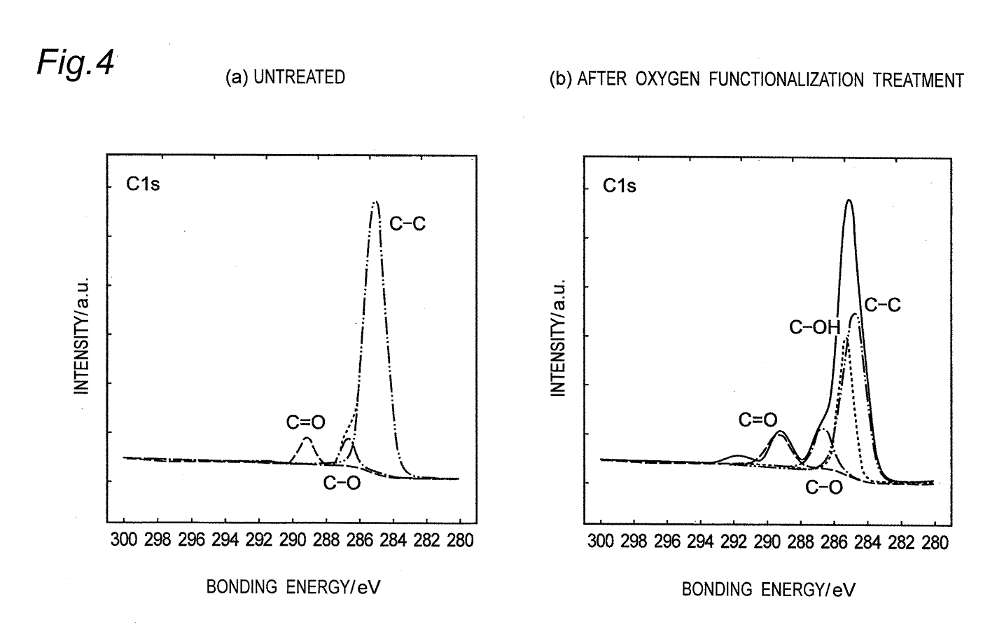

In order to confirm the functional group formed by the oxygen functionalization treatment, XPS analysis and infrared spectroscopy (hereinafter referred to as IR) analysis of each surface of the untreated and oxygen functionalized LCP films CT-Z were performed. The results of XPS analysis are shown in FIG. 4 and the results of IR analysis are shown in FIG. 5.

The XPS analysis charts of FIGS. 4(a) and 4(b) are compared. First, in the XPS spectrum of the untreated LCP film (FIG. 4(a)), peaks of C═O and C—O derived from the ester bond present in the polyester-based resin are confirmed. Next, in the XPS spectrum of the LCP film after the oxygen functionalization treatment (FIG. 4(b)), the height of the C═O and CO peaks increased and a C—OH peak newly appeared at around 285 to 286 eV.

Comparing the IR analysis charts of FIGS. 5(a) and 5(b), in the LCP film after the oxygen functionalization treatment, a strong absorption appeared in an aromatic OH group at 1,000 to 1,200 cm ⁻¹ as compared with the untreated LCP film.

The above results revealed that the C═O group and the C—O group are formed, mainly the C—OH group, by the oxygen functionalization treatment.

In the embodiment of the present invention, the oxygen-containing functional layer 30 may be a layer containing an oxygen functional group on at least a part thereof.

When the oxygen functional group is confirmed by the XPS analysis, it is preferable that the oxygen functional group is contained to such an extent that an increase in oxygen/carbon atomic ratio is confirmed as compared with the untreated polyester-based resin. For example, the oxygen functional group may be contained to such an extent that an increase in oxygen/carbon atomic ratio by 0.03 or more, preferably 0.05 or more, and most preferably 0.07 or more, is confirmed. Alternatively, in the XPS spectrum, an oxygen functional group may be contained at around 285 to 286 eV so that a C—OH peak can be newly confirmed.

When the oxygen functional group is confirmed by measuring the contact angle of water, it is preferable to contain the oxygen functional group to such an extent that a decrease in contact angle is confirmed as compared with the untreated polyester resin. For example, the oxygen functional group may be contained to such an extent that the contact angle of 10° or more, and preferably 15° or more, is confirmed. Alternatively, the oxygen functional group may be contained so that the contact angle itself of the oxygen-containing functional layer 30 becomes preferably 70° or less, more preferably 65° or less, and still more preferably 60° or less.

When the oxygen functional group is confirmed by IR analysis, it is preferable to contain the oxygen functional group to such an extent that absorption appears in the aromatic OH group at 1,000 to 1,200 cm⁻¹.

(5) Bonding of Copper Foil (Copper Alloy Substrate 10) and LCP Film with Oxygen-Containing Functional Group Layer 30 (Polyester-Based Resin Member 45)

As shown in FIG. 2(b), an upper surface of a copper foil (copper alloy substrate 10) and an oxygen-containing functional layer 30 of an LCP film subjected to an oxygen functionalization treatment (polyester resin member 45) are brought into face-to-face contact with each other, followed by pressurization using a press machine or the like. At this time, pressurization is performed while appropriately heating.

Since the oxygen-containing functional layer 30 has pressure bondability, the copper alloy substrate 10 and the polyester resin member 45 can be bonded to each other by pressurization.

It is possible for the copper alloy article 1 obtained by pressure bonding to increase the bonding strength between the copper alloy substrate 10 and the polyester-based resin body 40 by including the oxygen-containing functional layer 30. Thus, a study was made of a method of confirming whether or not the oxygen-containing functional layer 30 is included between the copper alloy substrate 10 and the polyester-based resin body 40, in the copper alloy article 1.

A study was made whether or not it is possible to confirm that the LCP film used in the copper alloy article has been subjected to an oxygen functionalization treatment by peeling and analyzing the copper foil and the LCP film bonded to each other, with respect to the copper alloy article 1, i.e., a method of confirming whether or not the oxygen-containing functional layer 30 is interposed between the copper foil and the LCP film.

As an LCP film, CT-F was used. An untreated or oxygen functionalized LCP film was bonded to a copper foil cleaned with an acid. Using a hot plate press, they were bonded to each other by pressing under a pressure of 4 MPa at a temperature of 285° C. for 10 minutes. Since pressing was performed at a temperature lower than the melting point of the LCP film, the LCP film was not melted.

The copper foil and the LCP film bonded to each other were peeled off and the peeling interface of the LCP film was subjected to XPS analysis, and a comparison was made of the oxygen/carbon atom ratio at the peeling interface of the untreated and oxygen functionalized LCP films. The results are shown in Table 5.

TABLE 5

| Sample | Oxygen/carbon atom ratio |
|---|---|
| Untreated LCP film/copper foil | 0.25 |
| Oxygen functionalized LCP | 0.30 |
| film/copper foil | |

When the untreated LCP film was bonded to the copper foil, the oxygen/carbon atomic ratio at the peeling interface of the LCP film was 0.25, whereas, when the oxygen functionalized LCP film was bonded to the copper foil, the oxygen/carbon atomic ratio at the peeling interface of the LCP film was 0.30. When the oxygen functionalized LCP film was applied, it was confirmed that the oxygen/carbon atom ratio was high also at the peeling interface.

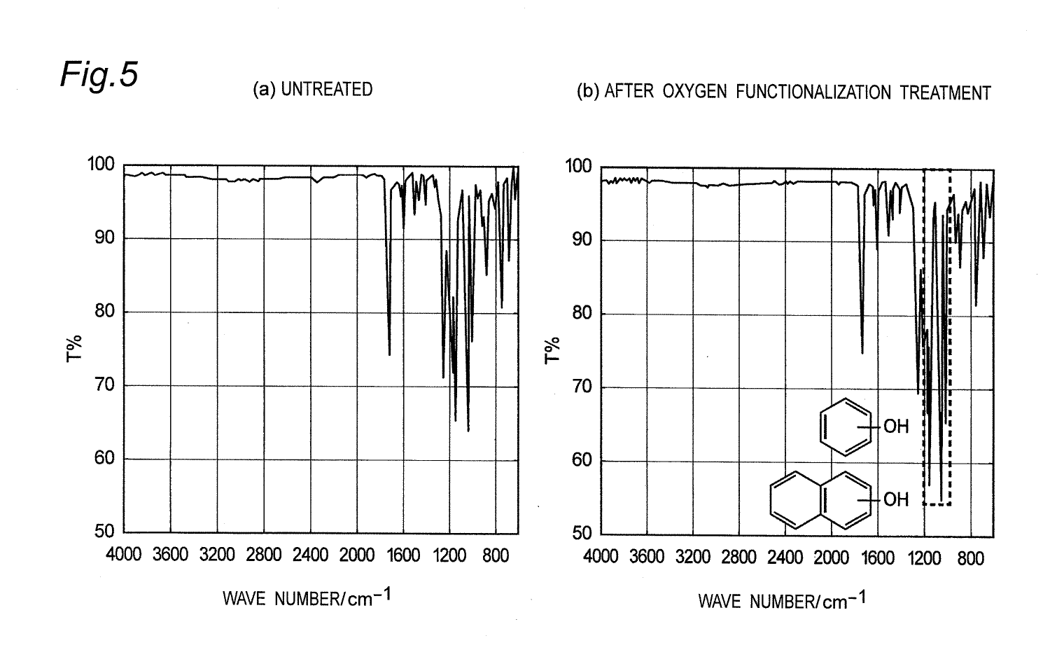

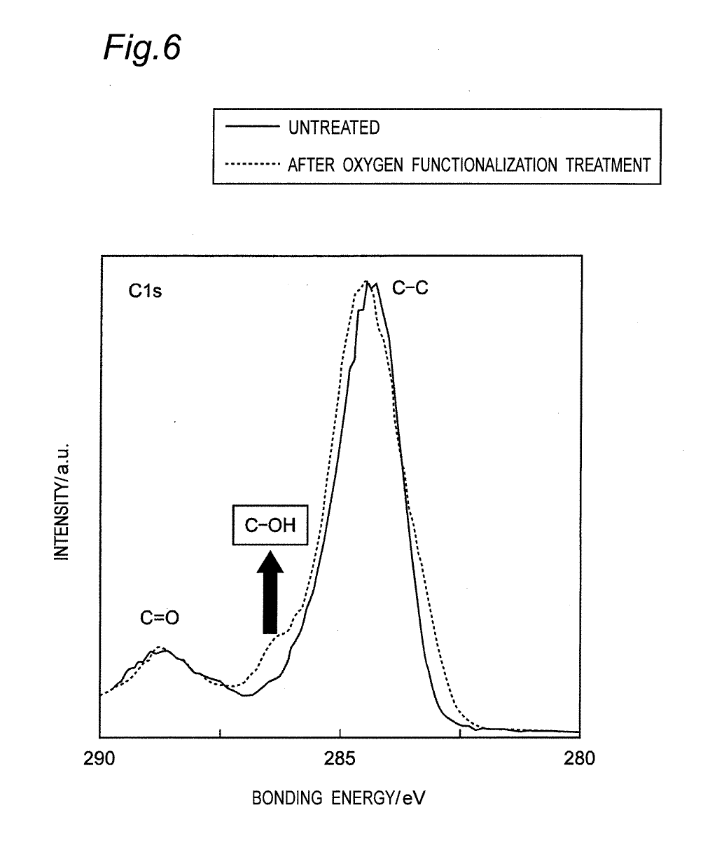

From the C1peak of XPS analysis of the peeling interface of the LCP film, a comparison was made of the analysis results of the C1s peak at the peeling interface of the untreated and oxygen functionalized LCP film. FIG. 6 shows the C1s peak of the peeling interface of the peeled LCP film. Solid and dashed lines indicate the untreated and oxygen functionalized LCP films, respectively. In the oxygen functionalized film, a shoulder of C—OH newly appeared at around 286 eV, which is not present in the untreated film.

That is, the above results can reveal that, when a copper alloy article 1 is produced using the polyester-based resin body 40 including the oxygen-containing functional layer 30 (polyester-based resin member 45), the presence of the oxygen-containing functional base layer 30 can be confirmed by peeling the copper alloy substrate 10 and the polyester-based resin body 40 and performing XPS analysis of the peeling interface of the polyester-based resin body 40. Therefore, it is possible to judge from the copper alloy article 1 that any one of the untreated or oxygen functionalized LCP films is used.

A method for producing a copper alloy article 1 according to the present embodiment will be described again with reference to FIGS. 2(a) and 2(b).

### <1-1. Formation of Oxygen-Containing Functional Group Layer 30>

As shown in FIG. 2(a), a surface of a polyester-based resin body 40 is irradiated with ultraviolet light (hν) in the presence of a hydrogen peroxide solution 50. Degradation of the hydrogen peroxide solution 50 and surface excitation of the polyester-based resin body 40 occur due to ultraviolet rays to form an oxygen-containing functional layer 30 on the surface of the polyester-based resin body 40, thus obtaining a polyester-based resin member 45.

The wavelength, the dose and the irradiation time of ultraviolet rays can be arbitrarily changed as long as the oxygen-containing functional layer 30 can be formed. The wavelength of ultraviolet rays can be set at, for example, 170 nm to 400 nm, and preferably 170 nm to 250 nm. The dose of ultraviolet rays can be set at, for example, 0.1 to 100 mW/cm². The irradiation time of the ultraviolet rays varies depending on the intensity of ultraviolet rays and can be set at, for example, 1 minute to 7 hours, and preferably 30 minutes to 3 hours.

The concentration of the hydrogen peroxide solution 50 can be set at any concentration as long as the oxygen-containing functional layer 30 can be formed by irradiation with ultraviolet rays. It is possible to employ the hydrogen peroxide solution having a concentration of preferably 1 to 30%, for example, 30%.

### <1-2. Cleaning of Copper Alloy Substrate 10>

The surface of the copper alloy substrate 10 is cleaned with an aqueous acid solution. Thereby, the oxide layer and the rust preventive present on the surface of the copper alloy substrate 10 can be removed.

It is possible to employ, as the aqueous acid solution, for example, an aqueous solution of an acid solution, such as sulfuric acid, hydrochloric acid, a mixed solution of sulfuric acid and chromic acid, a mixed solution of sulfuric acid and hydrochloric acid, or a mixed solution of sulfuric acid and nitric acid. Particularly, an aqueous sulfuric acid solution or an aqueous hydrochloric acid solution is preferable.

Cleaning can be performed by immersing the copper alloy substrate 10 in the aqueous acid solution for a predetermined time. The immersing time may be in any range as long as the oxide layer on the surface and the rust preventive can be removed and the copper alloy substrate 10 is not significantly eroded. For example, when 1% hydrochloric acid is used, the copper alloy substrate can be immersed for 30 seconds to 10 minutes (e.g., 1 minute). When 15% sulfuric acid is used, the copper alloy substrate may be immersed for 1 to 20 minutes (e.g., 5 minutes).

<1-3. Bonding of Copper Alloy Substrate 10 and Polyester-Based Resin Member 45>

As shown in FIG. 2(b), by pressing an oxygen-containing functional group layer 30 of a polyester-based resin member 45 and a cleaned copper alloy substrate 10 while they are brought into contact with each other, the polyester-based resin member 45 and the copper alloy substrate 10 are bonded to each other, thus making it possible to obtain a copper alloy article 1 as shown in FIG. 1 This can also be regarded as bonding the polyester-based resin body 10 of the polyester-based resin member 45 and the copper alloy substrate 10 to each other through the oxygen-containing functional layer 30 interposed therebetween.

It is preferable to heat the copper alloy substrate 10 and the polyester-based resin member 45 before or during pressurization since it becomes easy to bond. The heating temperature is set at the temperature at which the polyester-based resin body 40 of the polyester-based resin member 45 is not melted. Pressurization can be performed by setting at a surface pressure of 1 MPa to 8 MPa, e.g., 4 MPa.

### Embodiment 2

Embodiment 2 is different from Embodiment 1 in that the compound layer 20 is disposed between the copper alloy substrate 10 and the oxygen-containing functional layer 30. Other configurations are substantially the same as those of Embodiment 1. A difference between Embodiments 1 and 2 will be mainly described.

FIG. 7 is a schematic cross-sectional view of a copper alloy article 2 according to the second embodiment, in which a copper alloy substrate 10 and a polyester-based resin body 40 are bonded to each other, through a compound layer 20 and an oxygen-containing functional group layer 30 which are interposed therebetween.

### (5) Compound Layer

A compound contained in the compound layer 20 is preferably a compound having a nitrogen-containing functional group and a silanol group. When the polyester-based resin body 40 and the copper alloy substrate 10 are bonded to each other using a compound having a nitrogen-containing functional group and a silanol group by treating a surface of the polyester-based resin body 40 with the oxygen-containing functional layer 30, the silanol group of the compound reacts with an oxygen functional group of the oxygen-containing functional layer 30, thus achieving firm bonding. Thereby, the bonding force between the polyester-based resin body 40 and the copper alloy substrate 10 is improved. That is, by bonding the polyester-based resin body 40 and the copper alloy substrate 10 to each other through the oxygen-containing functional layer 30 and the compound layer 20 made of a compound having a nitrogen-containing functional group and a silanol group, the bonding strength can be increased as compared with the case of bonding through only the oxygen-containing functional group layer 30.

The nitrogen-containing functional group is effective for increasing the bonding strength to the copper alloy substrate 10 because of its high chemical adsorptivity to copper. The silanol group is effective for increasing the bonding strength to the polyester-based resin body 40 because of its high chemical adsorptivity to the oxygen-containing functional group of the polyester-based resin. Therefore, a compound having a nitrogen-containing functional group and a silanol group is suitable for bonding the copper alloy substrate 10 and the oxygen-containing functional layer 30 of the polyester-based resin body 40 to each other.

The “nitrogen-containing functional group” possessed by the compound preferably has a nitrogen-containing 5-membered or higher-membered cyclic structure. The nitrogen-containing 5-membered or higher-membered cyclic structure can be, for example, a triazole or triazine structure.

### Selection of Compound

Hereinafter, the bonding strength between various compounds and the copper alloy substrate was compared.

Five types of compounds shown in Table 6 (hereinafter, each compound is referred to as the symbol mentioned in Table 6) were selected. Regarding the compound whose chemical name is disclosed, the chemical name was described. Regarding the compound ImS which is not disclosed in detail, the disclosed basic structure was described. Main functional groups possessed by these compounds are shown in Table 7. It is known that an alkoxysilane group is converted into a silanol group in an aqueous solution. Among them, only the compound ET has no alkoxysilane group and is not a silane coupling agent.

TABLE 6

| | | Manufacturer |
|---|---|---|
| Symbol | Compound | Product name |
| ET | 1,3,5-Tris-(2,3-epoxypentyl)-1,3,5- | Nissan Chemical |
| | triazine-2,4,6(1H,3H,5H)trione | Industries, Ltd. |
| | | TEPIC-VL |
| AST | 2-(3-Triethoxysilylpropyl)amino-4,6- | Sulfur Chemical |
| | di(2-aminoethyl)amino-1,3,5-triazine | Laboratory Inc. |
| ImS | Imidazole-based silane compound | JX Nippon Mining & |
| | | Metals Corporation |
| | | IS-1000 |
| AAS | N-2(aminoethyl)-3- | Shin-Etsu Chemical |
| | aminopropyltrimethoxysilane | Co., Ltd. KBM-603 |
| AS | 3-Aminopropyltrimethoxysilane | Shin-Etsu Chemical |
| | | Co., Ltd. KBM-903 |

TABLE 7

| Symbol | Compound | Main functional group |
|---|---|---|
| ET | 1,3,5-Tris-(2,3-epoxypentyl)-1,3,5- | Basic structure: |
| | triazine-2,4,6(1H,3H,5H)trione | 6-Membered triazine ring |
| | | Epoxy group |
| | | Oxo group |
| AST | 2-(3-Triethoxysilylpropyl)amino- | Basic structure: |
| | 4,6-di(2-aminoethyl)amino-1,3,5- | 6-Membered triazine ring |
| | triazine | Alkoxysilane group |
| | | Amino group |
| ImS | Imidazole-based silane compound | Basic structure: |
| | | 5-Membered imidazole |
| | | ring |
| | | Alkoxysilane group |
| AAS | N-2(aminoethyl)-3- | Basic structure: Alkane |
| | aminopropyltrimethoxysilane | Alkoxysilane group |
| | | Amino group |
| AS | 3-Aminopropyltrimethoxysilane | Basic structure: Alkane |
| | | Alkoxysilane group |
| | | Amino group |

A copper foil, an LCP film (Vecstar CT-Z, manufactured by Kuraray Co., Ltd.) and a PET film (UF, manufactured by Teijin DuPont Films), which were cleaned with 1% hydrochloric acid for 1 minute and then sufficiently washed with ion exchanged water, were coated with five types of aqueous bonding compound solutions each having a concentration of 0.1% using a dip coater manufactured by J.P.0 Co., Ltd., followed by drying and further heat treatment at 100° C. for 5 minutes. The coated surface was analyzed by XPS analysis. The analysis results are summarized in Table 8. Regarding the PET film, only ET coating and AST coating were performed.

TABLE 8

| | XPS analysis results | | |
|---|---|---|---|
| Symbols | Copper foil | LCP film | PET film |
| ET | Cu2p orbital peak: | Cls orbital peak: | Cls orbital peak: |
| | only Cu (0-valent) peak | no chemical shift | no chemical shift |
| | exists at around 930-935 | exists in C—O/C═O | exists in C—O/C═O |
| | eV, and no Cu—N peak | peaks at 286-288 | peaks at 286-288 |
| | exists. Physical adsorption | eV. | eV. |
| AST | Cu2p orbital peak: | Cls orbital peak: | Cls orbital peak: |
| | Cu—N bond peak | chemical shift | chemical shift |
| | exists at around | exists in C—O/C═O | exists in C—O/C═O |
| | 936 eV, and no Cu | peaks at 286-288 eV | peaks at 286-288 eV |
| | (0-valent) peak exists. | | |
| ImS | Cu2p orbital peak: | Cls orbital peak: | |
| | Cu (0-valent) exists, | chemical shift exists in | |
| | and Cu—N bond peak | C—O/C═O peaks at | |
| | exists at around 936 eV. | 286-288 eV. Unreacted ester | |
| | | group exists at 289 eV. | |
| AAS | Cu2p orbital peak: Cu | Cls orbital peak: chemical | |
| | (0-valent) exists, and | shift exists in C—O/C═O | |
| | Cu—N bond peak exists | peaks at 286-288 eV. | |
| | at around 936 eV. | Unreacted ester group | |
| | | exists at 289 eV. | |
| AS | Cu2p orbital peak: Cu | Cls orbital peak: chemical | |
| | (0-valent) peak is high, | shift exists in C—O/C═O | |
| | and Cu—N bond peak exists | peaks at 286-288 eV. | |
| | at around 936 eV. | Unreacted ester group | |
| | | exists at 289 eV. | |

Compound ET

A compound ET is a compound having a nitrogen-containing functional group and a silanol group and has three epoxy groups and three oxo groups (C═O) in a 6-membered triazine ring containing three nitrogen atoms (N). In the copper foil coated with ET, a peak showing chemical adsorption between copper (Cu) and the N atom did not appear. In LCP and PET coated with ET, there is no chemical shift of the peak showing chemical adsorption with the epoxy group. These results revealed that ET does not chemically adsorbed to each surface of a copper foil, LCP and PET, and is only physically adsorbed.

### Compound AST

A compound AST is a compound having a nitrogen-containing functional group and a silanol group and has one alkoxysilane group and two amino groups in a 6-membered triazine ring containing three nitrogen atoms. In the copper foil coated with AST, when observing the Cu2p orbital peak of copper, a peak showing bonding between Cu and N was confirmed. In LCP and PET coated with AST, peaks showing C—O/C═O bonds appeared at 286 to 288 eV of the C1s orbital peak, and both peaks shifted from the peak position of the original film. These results revealed that, regarding AST, N of the 6-membered triazine ring and N of the amino group are chemically adsorbed to copper and the silanol group is chemically adsorbed to the ester structure of LCP and PET.

### Compound ImS

A compound ImS is a compound having a nitrogen-containing functional group and a silanol group and has a structure in which a 5-membered imidazole ring and one alkoxysilane group are connected to each other. In the copper foil coated with ImS, when observing the Cu2p orbital peak of copper, there was a peak showing bonding between Cu and N, which shows that the imidazole group is chemically adsorbed to copper. At the same time, there was also a peak of Cu (0-valent), which shows that there is a part where no ImS is present on the surface of copper. In AST, the peak of Cu (0-valent) was not observed, which showed that AST is chemically adsorbed to the copper surface at higher density than that of ImS.

Meanwhile, in LCP coated with ImS, the peak showing bonding of C-—O/C═O at 286 to 288 eV shifted from the peak position of the original film, which showed that chemical adsorption occurs. There was also a peak of the unreacted ester group at 289 eV, which showed that there was a portion where ImS is not chemically adsorbed to the LCP. In AST, since the peak of such unreacted ester group was not observed, it is judged that AST is higher in chemical adsorptivity to the ester structure of LCP than that of ImS.

### Compounds AAS and AS

Compounds AAS and AS are alkane type amine-based silane coupling agents and are typical compounds which are widely applied for bonding between copper and resins in the prior art document. In the copper foil coated with these compounds, when observing the Cu2p orbital peak of copper, there is a Cu (0-valent) peak like ImS, which showed that there is the portion where AAS or AS is not adsorbed on the surface of copper. Heretofore, a number of documents have addressed that the silanol group is chemically adsorbed to the copper surface. However, it became clear that, unlike the documents, the chemical adsorptivity of these compounds deteriorate on the copper surface cleaned sufficiently with an acid.

As mentioned previously, when the copper surface is cleaned with an acid until the antioxidant applied thereon is completely removed, the oxide of copper formed on the surface by being exposed to the natural environment is also removed, leading to drastic decrease in amount thereof. With regard to the silanol group chemically adsorbed to the oxide, adsorption sites have been markedly reduced on the surface of copper cleaned sufficiently with an acid. Meanwhile, since the Cu—N peak is observed, the amino group is chemically adsorbed on the copper foil surface. At the same time, the peak of Cu (0-valent) attributed to the copper surface, on which no compound is adsorbed, also appeared, which showed that the amino group of an alkane has low chemical absorptivity.

In LCP coated with AAS and AS, there is a peak of the unreacted ester group at 289 eV, and it is judged that the chemical adsorptivity to LCP is also low.

The substituent of the nitrogen-containing cyclic compound may be, in addition to the amino group of AST, a ureido group, an isocyanate group or the like.

Specification of Compound contained in Compound Layer

A relationship between each compound and the XPS spectrum was examined using ImS and AAS as the compounds.

An aqueous solution containing a predetermined compound was applied to an LCP film (CT-Z, manufactured by Kuraray Co., Ltd.) and then heat-treated at 100° C. for 5 minutes. The film of the compound formed on the surface of the LCP film was subjected to XPS analysis.

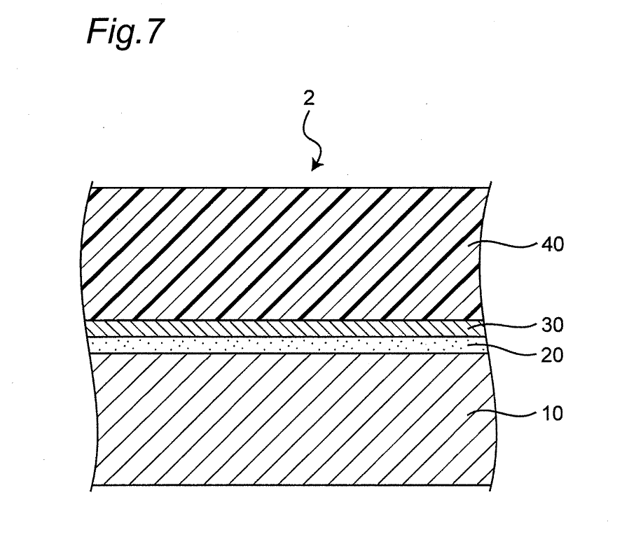

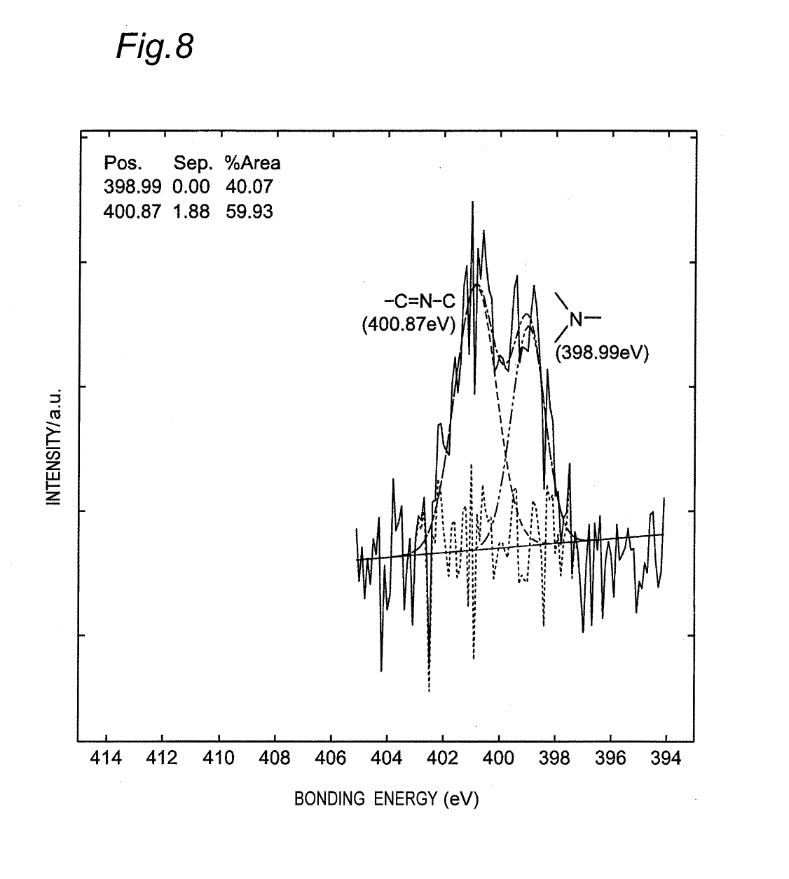

FIG. 8 shows an N1s peak of an XPS spectrum of the ImS film, and the spectrum is separated into two spectra by analysis software of the XPS spectrum.

The first peak appearing at the position of the binding energy of 400.87 eV is attributed to a nitrogen atom bonded by a double bond contained in the 5-member imidazole ring (labeled with “—C═N—C—” in FIG. 8).

The second peak appearing at the position of the binding energy of 398.99 eV is attributed to an amino type nitrogen atom contained in the 5-membered imidazole ring (labeled “>N—” in FIG. 8).

The intensity of the second peak is almost the same as that of the first peak.

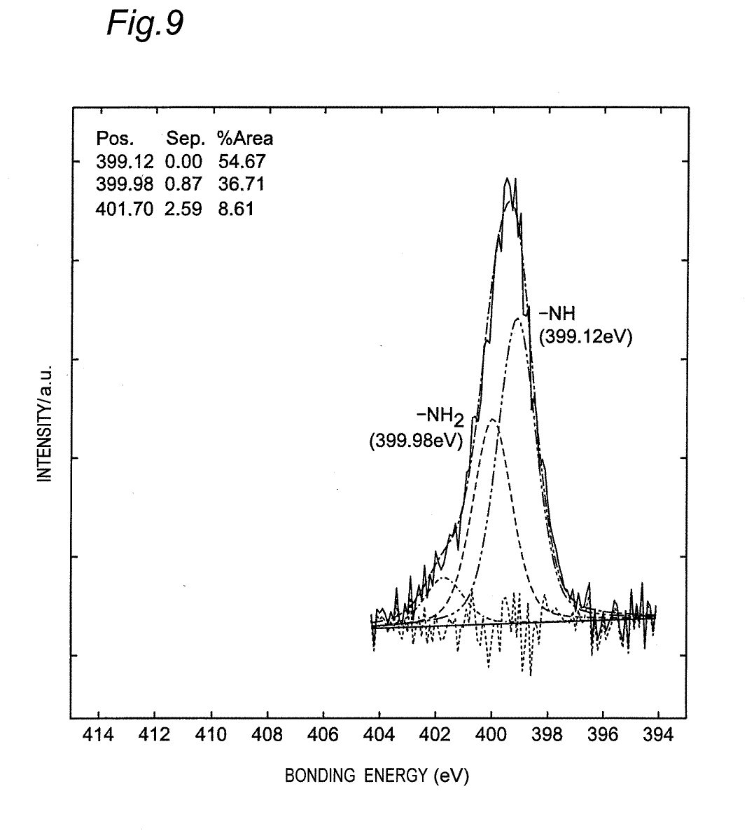

FIG. 9 shows an N1s peak of an XPS spectrum of the AAS film, and the spectrum is separated into three spectra by analysis software.

The peak appearing at the position of the binding energy of 399.98 eV is attributed to a nitrogen atom of a primary amino group (labeled with “—NH₂” in FIG. 9).

The peak appearing at the position of the binding energy of 399.12 eV is attributed to a nitrogen atom of a secondary amino group (labeled with “—NH” in FIG. 9).

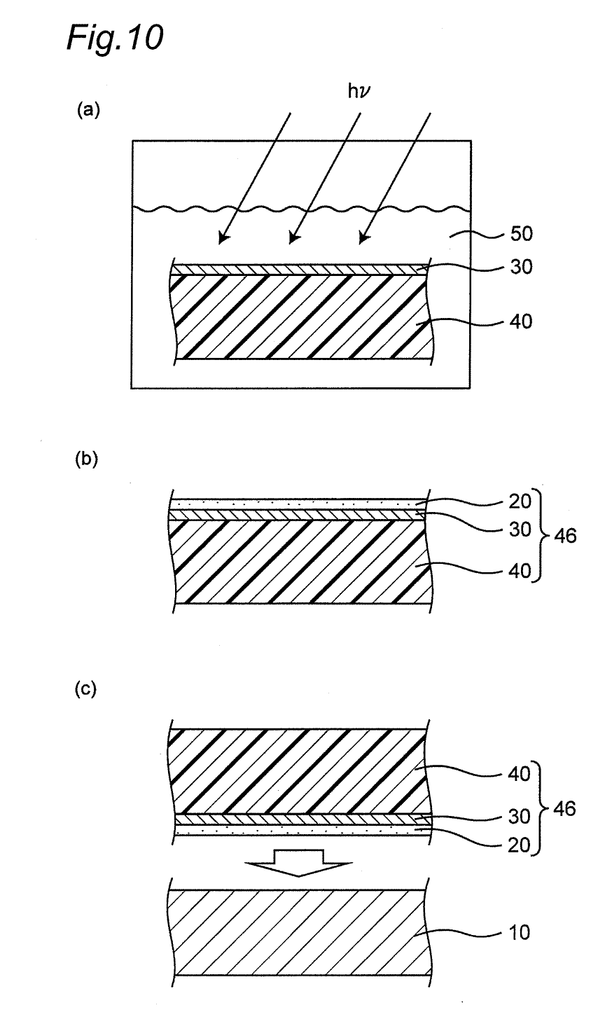

A method for producing a copper alloy article 1 according to the present embodiment will be described below with reference to FIGS. 10(a) to 10(c).

### <2-1. Formation of Oxygen-Containing Functional Group Layer 30>

As shown in FIG. 10(a), the surface of the polyester-based resin body 40 is irradiated with ultraviolet light (hν) in the presence of a hydrogen peroxide solution 50. Degradation of the hydrogen peroxide solution 50 and surface excitation of the polyester-based resin body 40 occur due to ultraviolet rays, and the oxygen-containing functional layer 30 is formed on the surface of the polyester-based resin body 40.

The details of the formation of the oxygen-containing functional layer 30 are the same as those in Embodiment 1.

### <2-2. Formation of Compound Layer 20>

A solution containing a compound having a nitrogen-containing functional group and a silanol group is brought into contact with the oxygen-containing functional layer 30 formed on the surface of the polyester-based resin body 40. The solution can be brought into contact with the surface of the oxygen-containing functional layer 30 by a known method such as coating or spraying. Thereafter, a heat treatment is performed, thus making it possible to form the compound layer 20 on the surface of the oxygen-containing functional layer 30 (FIG. 10(b)). Thereby, a polyester resin member 46 including the polyester-based resin body 40, the oxygen-containing functional layer 30 and the compound layer 20 is obtained.

In a compound having a nitrogen-containing functional group and a silanol group, it is preferable that the nitrogen-containing functional group has a nitrogen-containing 5-membered or higher-membered cyclic structure. It is particular preferable that the 5-membered or higher-membered cyclic structure is a triazole or triazine structure. Examples of specific compounds include AST analogous compounds in which a part of functional groups of AST, ImS and AST mentioned in Table 6 are substituted with other functional groups, imidazole silane coupling agents and the like. Examples of the AST analogous compound include compounds in which a triethoxy group of AST is substituted with a trimethoxy group, and compounds in which an amino substituent of a 4,6-di(2-aminoethyl)amino group of AST is substituted with an N-2-(aminoethyl)-3-aminopropyl group, a 3-aminopropyl group, an N-(1,3-dimethyl-methylidyne)propylamino group, an N-phenyl-3-aminopropyl group, an N-(vinylbenzyl)-2-aminoethyl-3-aminopropyl group or a 3-ureidopropyl group. Examples of the imidazole silane coupling agent include tris-(trimethoxysilylpropyl)isocyanurate, and those having any one of a 1-imidazolyl group, a 3-imidazolyl group and a 4-imidazolyl group, together with a trialkoxysilyl group such as a trimethoxy group or a triethoxy group.

### <2-3. Cleaning of Copper Alloy Substrate 10>

The surface of the copper alloy substrate 10 is cleaned with an aqueous acid solution. Thereby, the oxide layer and the rust preventive present on the surface of the copper alloy substrate 10 can be removed.

Details of cleaning of the copper alloy substrate 10 are the same as in Embodiment 1.

### <2-4. Bonding of Copper Alloy Substrate 10 and Polyester-Based Resin Member 46>

As shown in FIG. 10(c), by pressing a compound layer 20 of a polyester-based resin member 46 and a cleaned copper alloy substrate 10 while they are brought into contact with each other, the polyester-based resin member 46 and the copper alloy substrate 10 are bonded to each other, thus making it possible to obtain a copper alloy article 2 as shown in FIG. 7. This can also be regarded as bonding the polyester-based resin body 40 of the polyester-based resin member 46 and the copper alloy substrate 10 to each other, through the oxygen-containing functional layer 30 and the compound layer 20 which are interposed therebetween.

The details of pressure bonding are the same as in Embodiment 1.

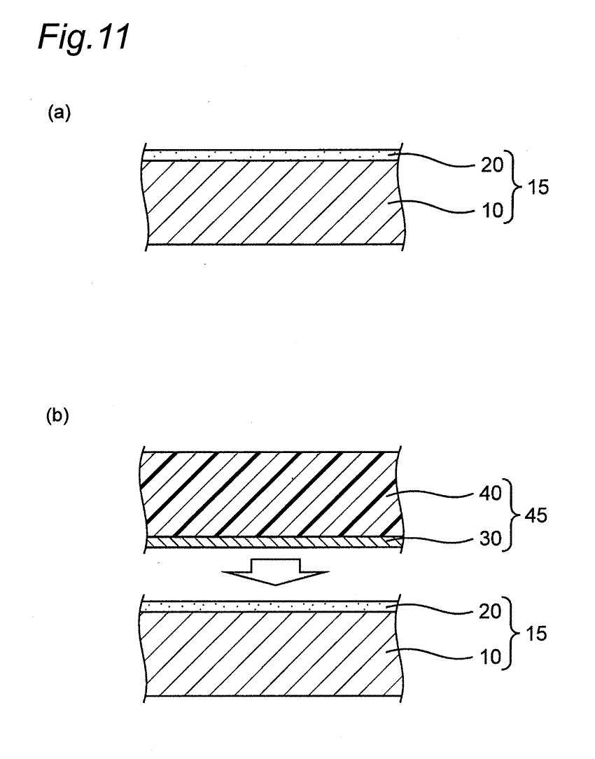

As a modification of the production method, the compound layer 20 may be formed on the surface of the copper alloy substrate 10. Modifications will be described with reference to FIGS. 11(a) and 11(b).

### <3-1. Formation of Oxygen-Containing Functional Group Layer 30>

By the same step as the step 1-1. of Embodiment 1, an oxygen-containing functional layer 30 is formed on the surface of the polyester-based resin body 40 to obtain a polyester resin-based member 45 (FIG. 2(a)).

### <3-2. Cleaning of Copper Alloy Substrate 10>

By the same step as the step 1-2. of Embodiment 1, the surface of the copper alloy substrate 10 is cleaned with an aqueous acid solution to remove the oxide layer and the rust preventive present on the surface of the copper alloy substrate 10.

### <3-3. Formation of Compound Layer 20>

A solution containing a compound having a nitrogen-containing functional group and a silanol group is brought into contact with the surface of the cleaned copper alloy substrate 10. Thereafter, a heat treatment is performed, thus making it possible to form a compound layer 20 on the surface of the copper alloy substrate 10 (FIG. 11(a)). Thereby, a copper alloy member 15 including the copper alloy substrate 10 and the compound layer 20 is obtained.

The details of the compound layer 20 are as the same as in the step 2-2.

### <3-4. Bonding of Copper Alloy Member 15 and Polyester-Based Resin Member 45>

As shown in FIG. 11(b), by pressing an oxygen-containing functional layer 30 of a polyester resin member 45 and a compound layer 20 of a copper alloy member 15 while they are brought into contact with each other, the polyester-based resin member 45 and the copper alloy substrate 15 are bonded to each other, thus making it possible to obtain a copper alloy article 2 as shown in FIG. 7.

The details of pressurized connection are the same as those in Embodiment 1.

The polyester resin-based member 46 including the compound layer 20 (FIG. 10(b)) and the copper alloy member 15 including the compound layer 20 (FIG. 11(a)) are prepared and these compound layers 20 are pressed by bringing into contact with each other, thus making it possible to obtain a copper alloy article 2 as shown in FIG. 7.

### EXAMPLES

Properties of the copper alloy article according to the present invention will be described by way of Examples.

### Example 1

The effect of oxygen functionalization of an LCP film was investigated using a film for a cover as the LCP film. CT-F (manufactured by Kuraray Co., Ltd.) was used as the film for a cover. A 25 μm-thick CT-F was cut into square with each side of 150 mm to prepare two test pieces (CT-F pieces). One test piece of two CT-F pieces was placed in a reaction vessel made of synthetic quartz together with an aqueous 30% aqueous hydrogen peroxide, and then an oxygen functionalization treatment was performed by irradiating with light from an excimer lamp at room temperature for 30 minutes to 3 hours (treated CT-F piece). The other CT-F piece was not subjected to the oxygen functionalization treatment (untreated CT-F piece).

A copper foil B (manufactured by UACJ Foil Corporation, thickness: 18 μm) was cleaned with 1% hydrochloric acid for 1 minute, sufficiently washed with ion exchanged water, and then dried. The copper foil B was cut into square with each side of 150 mm to prepare four test pieces (copper foil pieces).

The copper foil piece was placed on both surfaces of the untreated CT-F piece not subjected to the oxygen functionalization treatment and the treated CT-F piece subjected to the oxygen functionalization treatment, respectively. After holding at 90° C. for 10 minutes, using a vacuum press machine manufactured by Kitagawa Seiki Co., Ltd., pressurization was performed under a surface pressure of 4 MPa, followed by holding at 290° C. for 10 minutes to prepare a double-sided copper clad laminate. A double-sided copper clad laminate using the treated CT-F pieces was regarded as Example 1, and a double-sided copper clad laminate using the untreated CT-F piece was regarded as

### Comparative Example 1.

A test piece was cut out from the double-sided copper clad laminates of Example 1 and Comparative example 1 in a strip shape and then subjected to measurement of a peeling strength. In accordance with JIS C 6471 8.1 “Peeling Strength of Copper Foil”, the entire surface of the copper foil on the back surface of the strip-shaped test piece was removed by etching, and then a pattern with a width of 10 mm was left on a tested surface (front surface) by etching to prepare a peeling test piece. The back surface (CT-F is completed exposed) of the peeling test piece was fixed to a reinforcing plate using a double-sided tape and the copper foil was peeled in the 180° direction at a peeling rate of 50 mm/min using Autograph AGS-5kNX manufactured by Shimadzu Corporation, followed by the measurement of the peeling strength. Using three test pieces, the measurement was performed. From the peeling test chart, the minimum value and the maximum value were read. The results are shown in Table 9.

TABLE 9

| | | | Peeling | |
|---|---|---|---|---|
| | | Treatment of | strength | Peeling |
| | Sample | CT-F | (kN/m) | state |
| Comparative | CT-F/copper | Untreated | 0.09/0.11 | Interfacial |
| Example 1 | foil | | | peeling |
| Example 1 | | Oxygen | 0.51/0.61 | Cohesive |
| | | functionalized | | peeling |

In Comparative Example 1 using the untreated CT-F, the copper foil was easily peeled off, and the minimum value and the maximum value of the peeling strength were 0.09 kN/m and 0.11 kN/m, respectively. Meanwhile, in Example 1 using the treated CT-F subjected to the oxygen functionalization treatment, cohesive peeling occurred in which peeling occurs in a state where CT-F adheres to the peeling interface of the copper foil. In other words, because of strong bonding force between the copper foil and CT-F, CT-F was broken in the CT-F layer instead of peeling at the interface. The minimum value and the maximum value of the peeling strength at this time were 0.51 kN/m and 0.61 kN/m, respectively, which were improved about 6 times the untreated one.

As mentioned above, it was found that CT-F, which is a film for a cover, is strongly bonded to the copper foil (cleaned with an acid to remove the antioxidant and oxide on the surface) by subjecting to an oxygen functionalization treatment.

### Example 2

Using a film for a base as the LCP film, the effect of oxygen functionalization of the LCP film was investigated. CT-Z (manufactured by Kuraray Co., Ltd.) was used as the film for a base. A 50 μm-thick CT-Z was cut into square with each side of 150 mm to prepare two test pieces (CT-Z pieces). One test piece of two CT-Z pieces was subjected to an oxygen functionalization treatment in the same manner as in Example 1.

A copper foil B (manufactured by UACJ Foil Corporation, thickness: 18 μm) was treated in the same manner as in Example 1 to prepare four copper foil pieces.

The copper foil piece was placed on both surfaces of the untreated CT-Z piece not subjected to the oxygen functionalization treatment and the treated CT-Z piece subjected to the oxygen functionalization treatment, respectively. Then, the temperature was raised to 270° C. while pressurizing under a surface pressure of 4 MPa using a vacuum press machine manufactured by Kitagawa Seiki Co., Ltd., followed by holding for 20 minutes and further holding at 290° C. for 10 minutes to prepare a double-sided copper clad laminate. A double-sided copper clad laminate using the treated CT-Z piece was regarded as Example 2, and a double-sided copper clad laminate using the untreated CT-Z piece was regarded as Comparative Example 2.

In the same manner as in Example 1, a peeling sample piece was prepared and the peeling strength was measured. The results are shown in Table 10.

TABLE 10

| | | Peeling | |
|---|---|---|---|
| | Treatment of | strength | Peeling |
| | CT-Z | (kN/m) | state |
| Comparative | Untreated | 0.16/0.20 | Interfacial |
| Example 2 | | | peeling |
| Example 2 | Oxygen | 0.22/0.28 | Cohesive |
| | functionalized | | peeling |

In Comparative Example 2 using the untreated CT-Z, the copper foil was peeled off relatively easily, and the minimum value and the maximum value of peeling strength were 0.16 kN/m and 0.20 kN/m, respectively. Meanwhile, in Example 2 using the treated CT-Z subjected to the oxygen functionalization treatment, cohesive peeling occurred in which peeling occurs in a state where CT-Z adheres to the peeling interface of the copper foil. The minimum value and the maximum value of the peeling strength at this time were 0.22 kN/m and 0.28 kN/m, respectively, which were improved about 1.4 times the untreated one.

As mentioned above, it was found that the bonding force to the copper foil is improved by subjecting CT-Z, which is a film for a base, to an oxygen functionalization treatment. However, in the film CT-Z for a base, an improvement in bonding strength equivalent to that obtained in the film CT-F for a cover of Example 1 was not achieved. As mentioned above, the improvement in bonding strength with the copper foil due to the oxygen functionalization treatment is confirmed in the entire LCP film, and it can be said that it is remarkable especially in the film for a cover.

### Examples 3 to 5

Using a film for a base as the LCP film, an influence of oxygen functionalization of the LCP film on the bonding strength with the compound layer was investigated. CT-Z (manufactured by Kuraray Co., Ltd.) was used as a film for a base.

A 50 μm-thick CT-Z was cut into square with each side of 150 mm to prepare three test pieces (CT-Z pieces), which were subjected to an oxygen functionalization treatment in the same manner as in Example I (treated Ct-Z piece).

A copper foil B (manufactured by UACJ Foil Corporation, thickness: 18 μm) was treated in the same manner as in Example 1 to prepare three copper foil pieces.

An aqueous 0.1% solution of a predetermined compound (AAS, ImS, AST) was applied to both the treated CT-Z piece and the copper foil piece using a dip coater manufactured by JSP Co., Ltd. Thereafter, a heat treatment was performed at 100° C. for 5 minutes. A copper foil was placed on the treated CT-Z piece so that the surface coated with the compound of the treated CT-Z piece faced the surface coated with the compound of the copper foil piece, and then a copper clad laminate was produced under the same conditions as in Example 1. Thereby, a compound layer can be formed between CT-Z and the copper foil.

In this Example, the aqueous compound solution was applied to both the treated CT-Z piece and the copper foil piece. Alternatively, a compound layer may be formed between CT-Z and the copper foil by applying the aqueous compound solution to any one of the treated CT-Z piece and the copper foil piece, and laying the other one of them on the coated surface. That is, it is possible to appropriately determine the surface to be coated depending on the wettability of the compound solution, the ease of formation of a compound layer, the required amount of the compound and the like.

Since copper cleaned with an acid has high activity, oxidation of copper is likely to occur during a heat treatment and hot pressing. However, in this method of forming a compound layer, discoloration due to oxidation of the copper surface did not occur. It is considered that oxidation of the copper foil piece was prevented by the aqueous compound solution applied onto the surface of the copper foil piece.

Among copper clad laminates, a copper clad laminate using ImS as the compound was regarded as Example 3, a copper clad laminate using AST as the compound was regarded as Example 4, and a copper clad laminate using AAS as the compound was regarded as Example 5, respectively.

In the same manner as in Example 1, a peeling sample piece was prepared and the peeling strength was measured. The results are shown in Table 11.

TABLE 11

| | | | Peeling strength (kN/m) |
|---|---|---|---|
| | Treatment | Copper | (Minimum value/maximum |
| | of LCP film | foil | value) |
| Example 3 | 0.1% ImS | 0.1% ImS | 0.32/0.42 |
| Example 4 | 0.1% AST | 0.1% AST | 0.44/0.54 |
| Example 5 | 0.1% AAS | 0.1% AAS | 0.29/0.35 |

In Example 3, the compound layer was formed from ImS having a 5-membered triazole ring containing a nitrogen atom, and the maximum value and the minimum value of the peel strength were 0.32 kN/m and 0.42 kN/m, respectively, and the peeling strength became about 1.5 times the peeling strength (the maximum value and the minimum value were 0.22 kN/m and 0.28 kN/m, respectively) of Example 2, which does not form a compound layer.

In Example 4, the compound layer was formed from AST having a 6-membered triazine ring containing a nitrogen atom and two amino groups, and the maximum value and the minimum value of the peel strength were 0.44 kN/m, 0.54 kN/m, and the peeling strength became about two times the peeling strength of Example 2.

In Example 5, the compound layer was formed from the alkane type amine-based silane coupling agent AAS, and the minimum value and the maximum value of the peeling strength were 0.29 kN/m and 0.35 kN/m, respectively, and the peeling strength became about 1.3 times the peeling strength of Example 2.

As is apparent from the results of Examples 3 to 5, the peeling strength is improved by subjecting a CT-Z film, which is a film for a base, to an oxygen functionalization treatment to form an oxygen-containing functional layer 30 and bonding with a copper alloy substrate through a compound layer 20 interposed between the CT-Z film and the copper alloy substrate.

Particularly, in Examples 3 and 4, high effect of improving the peeling strength was exerted. As is apparent from these results, the compound layer having a nitrogen-containing functional group and a silanol group preferably has a 5-membered or high-membered nitrogen-containing cyclic structure and the 5-membered or high-membered nitrogen-containing cyclic structure is preferably a triazole or a triazine ring.

As a result of XPS analysis of surface of the sample obtained by forming a compound layer on a surface of the treated CT-Z piece, it was confirmed that the compound layer is immobilized on the surface of the CT-Z piece.

In Example 4, an AST layer was formed on the surface of the treated CT-Z piece, and then XPS analysis was performed to determine the nitrogen/carbon atomic ratio. For comparison, XPS analysis of the treated CT-Z piece of Example 2, i.e., a sample formed with no compound layer, was also performed to determine the nitrogen/carbon atomic ratio. The results are shown in Table 12.

TABLE 12

| | Compound AST | Oxygen/carbon atom ratio |
|---|---|---|
| Example 2 | Untreated | 0.38 |
| Example 4 | Coated | 0.51 |

In the treated CT-Z piece of Example 2, the oxygen/carbon atom ratio was 0.38, and the results (0.35) shown in aforementioned Table 4 was nearly reproduced. Meanwhile, in the treated CT-Z piece coated with the AST layer of Example 4, the oxygen/carbon atom ratio became 0.51 and the ratio of oxygen atoms increased. These results could reveal that AST is immobilized on the LCP film by applying an AST solution and subjecting to a heat treatment.

A compound layer was formed using the aqueous AAS solution used in Example 5. An aqueous 0.1% solution of AAS was applied to both the treated CT-Z piece and copper foil piece using a dip coater manufactured by JSP Co., Ltd. Thereafter, a heat treatment was performed at 100° C. for 5 minutes. A copper foil was placed on the treated CT-Z piece so that the surface coated with the compound of the treated CT-Z piece faced the surface coated with the compound of the copper foil piece, and then a copper clad laminate was produced under the same conditions as in Table 13. For comparison, the same treatment was performed using an untreated CT-Z piece to prepare a copper clad laminate. During pressure bonding, a hot plate of a press was heated to 280° C. and held for 20 minutes. The pressing pressure 1 Ton corresponds to the surface pressure of 9 MPa. The peeling strength of the thus obtained copper clad laminate was measured. The results are shown in Table 13.

TABLE 13

| | | | |
|---|---|---|---|
| | | Peeling strength | |
| | | (N/mm) | Strength |
| | Pressing | Oxygen | improvement |
| Temperature | pressure | functionalization | ratio |

| ° C. | Ton | None | Yes | Times |
|---|---|---|---|---|
| 280 | 1 | 0.090 | 0.150 | 1.7 |
| | 2 | 0.035 | 0.175 | 5.0 |
| | 3 | 0.035 | 0.060 | 1.7 |

Under any press pressure, the peeling strength of the copper clad laminate using the treated CT-Z piece was 1.7 to 5.0 times the peeling strength of the copper clad laminate using the untreated CT-Z piece. The reason is considered that the wettability to the AAS solution was improved by the oxygen functionalization treatment, thus making it possible to apply on the entire surface of the CT-Z piece in a comparatively uniform manner.

In the embodiment of the present invention, in a copper alloy article in which a polyester-based resin member and a copper alloy substrate are bonded to each other, it is possible to bond the polyester-based resin member and the copper alloy substrate to each other by forming an oxygen-containing functional layer on the surface of the polyester-based resin.

When a compound layer containing a compound having a cyclic structure containing a silanol group and nitrogen is formed between the oxygen-containing functional layer and the copper alloy substrate, it is possible to more firmly bond the polyester-based resin body and the copper alloy base to each other.

While some embodiments according to the present invention have been illustrated, it is needless to say that the present invention is not limited to aforementioned embodiments and can be arbitrary without departing from the scope of the present invention.

This application claims priority based on Japanese Patent Application No. 2016-119105 filed on Jun. 15, 2016, the disclosure of which is incorporated by reference herein.

### DESCRIPTION OF REFERENCE NUMERALS

1, 2 Copper alloy article

10 Copper alloy substrate

20Compound layer

30 Intermediate layer (Oxygen-containing functional group layer)

40 Polyester-based resin body

45 Polyester-based resin member

50 Hydrogen peroxide solution

1-19. (canceled)

20. A copper alloy article comprising:
a substrate made of a copper alloy;
a polyester-based resin body;
an intermediate layer disposed between the substrate and the polyester-based resin body; and
a compound layer between the substrate and the intermediate layer, wherein
the intermediate layer contains an oxygen functional group, and
the compound layer contains a compound having a silanol group and a nitrogen-containing functional group having a nitrogen-containing 5-membered ring.

21. The copper alloy article according to claim 20, wherein the 5-membered ring is a triazole ring.

22. The copper alloy article according to claim 20, wherein the polyester-based resin body is made of a polyester-based resin selected from the group consisting of polyethylene terephthalate, polymethylene terephthalate, polybutylene terephthalate, polyethylene naphthalate, polybutylene naphthalate and a liquid crystal polymer.

23. The copper alloy article according to claim 20, wherein the substrate has a surface roughness Ra of 0.1 μm or less.

24. The copper alloy article according to claim 20, wherein an oxide layer and a rust preventive layer are absent on a surface of the substrate.

25. A polyester-based resin member comprising:
a polyester-based resin body;
an intermediate layer containing an oxygen functional group on a surface of the polyester-based resin body; and
a compound layer on the intermediate layer, wherein
the compound layer contains a compound having a silanol group and a nitrogen-containing functional group having a nitrogen-containing 5-membered or higher-membered cyclic structure.

26. The polyester-based resin member according to claim 25, wherein the 5-membered or higher-membered cyclic structure is a triazole or triazine structure.

27. The polyester-based resin member according to claim 25, wherein the polyester-based resin body is made of a polyester-based resin selected from the group consisting of polyethylene terephthalate, polymethylene terephthalate, polybutylene terephthalate, polyethylene naphthalate, polybutylene naphthalate and a liquid crystal polymer.

28. A method for producing a copper alloy article comprising; a substrate made of a copper alloy, a polyester-based resin body, a compound layer and an intermediate layer disposed between the substrate and the polyester-based resin body, the method comprising:
irradiating a surface of the polyester-based resin body with ultraviolet light in the presence of a hydrogen peroxide solution to form an intermediate layer containing an oxygen functional group on the surface of the polyester-based resin body;
bringing the intermediate layer into contact with a solution containing a compound having a nitrogen-containing functional group and a silanol group, followed by a heat treatment to form a compound layer;
cleaning a surface of the substrate with an aqueous acid solution; and
bonding the compound layer and the cleaned surface of the substrate to each other, thereby bonding the substrate and the polyester-based resin body to each other.

29. The method according to claim 28, wherein the nitrogen-containing functional group has a nitrogen-containing 5-membered or higher-membered cyclic structure.

30. The method according to claim 29, wherein the 5-membered or higher-membered cyclic structure is a triazole or triazine structure.

31. A method for producing a copper alloy article comprising; a substrate made of a copper alloy, a polyester-based resin body, and a compound layer and an intermediate layer disposed between the substrate and the polyester-based resin body, the method comprising:
irradiating a surface of the polyester-based resin body with ultraviolet light in the presence of a hydrogen peroxide solution to form an intermediate layer containing an oxygen functional group on a surface of the polyester-based resin body;
cleaning the substrate with an aqueous acid solution;
bringing the cleaned substrate into contact with a solution containing a compound having a silanol group and a nitrogen-containing functional group having a nitrogen-containing 5-membered ring, followed by a heat treatment to form a compound layer; and
bonding the intermediate layer and the compound layer to each other, thereby bonding the substrate and the polyester-based resin body to each other.

32. The method according to claim 31, wherein the 5-membered ring is a triazole ring.

33. A method for surface modification of a polyester-based resin body, the method comprising:
irradiating a surface of the polyester-based resin body with ultraviolet light in the presence of a hydrogen peroxide solution to form an intermediate layer containing an oxygen functional group on the surface; and
bringing the intermediate layer formed on the surface into contact with a compound having a nitrogen-containing functional group and a silanol group, followed by a heat treatment to form a compound layer.

34. The method according to claim 33, wherein the nitrogen-containing functional group has a nitrogen-containing 5-membered or higher-membered cyclic structure.

35. The method according to claim 34, wherein the 5-membered or higher-membered cyclic structure is a triazole or triazine structure.
